(19) United States
(12) Patent Application Publication
(10) Pub. No.: US 2016/0132473 A1
(43) Pub. Date: May 12, 2016

(54) TransDocument Views and Environment

(71) Applicant: Jesse Clement Bunch, Silver Spring, MD (US)

(72) Inventor: Jesse Clement Bunch, Silver Spring, MD (US)

(21) Appl. No.: 14/720,790

(22) Filed: May 24, 2015

Related U.S. Application Data
(60) Provisional application No. 61/998,596, filed on Jul. 2, 2014.
(60) Provisional application No. 61/997,167, filed on May 23, 2014.

(51) Int. Cl. G06F 17/24; G06F 17/30; G06F 3/0484

(52) U.S. Cl. CPC G06F 17/24; G06F 3/04842; G06F 17/3089

(57) ABSTRACT

This invention provides means to easily create, edit, and display documents that have very sophisticated capabilities. Every element, including for example, every pixel of every letter can edited by the most powerful and appropriate editor and can point to more information regarding that element. For example, spreadsheets in text documents have the full editing power of a native spreadsheet and text in spreadsheets to have the full editing power of word processing software and images in either to have access to the full image editing power of the best image editing software. Every element of a document such as text, numbers, images; video, etc. can invoke one or more form of Expanded Information, such as—a View, a Report, a document, website, etc. Expand Information includes educational materials on selected elements. The educational module also provides means to record, analyze and distribute the educational experiences of the user.

### CROSS REFERENCE TO RELATED APPLICATIONS

This application claims priority to U.S. Provisional Application No. 61/997,167, filed May 23, 2014, by Jesse Clement Bunch, entitled “Views”, and to U.S. Provisional Application No. 61/998,596, filed Jul. 2, 2014, by Jesse Clement Bunch, entitled “Views 2.0”, the disclosures in which are incorporated herein in their entireties by this reference.

### FIELD OF THE INVENTION

The present invention provides powerful editing tools for each data type in mixed data type documents and supports the user's ability to easily access more information on each data element. An environment is provided to integrate the improvements and add others. Many of the improvements can be used separately or together as plug-ins or add-ons to various applications or as apps in various browsers.

### BACKGROUND

Before the development of word processing, spreadsheet, and graphics software, documents were handwritten or typed. Thus, each element of a document (letter, word, phrase, number, photo, video, chart, etc.) was an “endpoint”, an object about which one could not directly access more information without, for example, looking up the meaning of it in a dictionary or getting more information by getting documents for specifically cited information. Word processing, spreadsheet and graphics software greatly amplified the productivity of users, yet still required a separate action to access more information on an element in a document. With the development of websites, the hyperlink was developed that permits the direct access to additional information, initially on web pages and later in documents. On websites, clicking on some pictures activates a hyperlink for more information regarding that picture. In spreadsheets produced by software, a calculated number, when clicked reveals the calculation that produced that number. Hyperlinks on words in documents and web pages are explicit and limited to pre-defined specific locations. The use of hyperlinks in documents is infrequent which is why each is typically designated with an underscore and its text is a different color. Liquid Words was an add-on to internet browsers that provided a number of options when any word was selected on a web page. Liquid Words did not provide those capabilities to non-internet documents. Liquid Words provided a single interface for all words, but only words.

Conventional software is much less orthogonal than is optimal. For example, MS Word contains table processing that is much less functional than Excel and Excel has text processing options that are much less functional than MS Word. Software modules that process only text are inherently different than those that process only spreadsheets and both are different from software modules that only process images. Trying to mix the functionality in a given module makes the code for each larger, slower, more complex, harder to maintain and upgrade, and the software harder to use.

### SUMMARY

In Views, every element in a document can be selected and acted upon in very powerful ways. Every element, including for example, every pixel of every letter can edited by the most powerful and appropriate editor and can point to more information regarding that element. Views documents employ Differently Treated Areas (DTAs) within the document wherein the data is managed by a module dedicated to that type of data, e.g. text, numbers (spreadsheet), slideshow, image, etc. This permits, for example, spreadsheets in text documents to have the full editing power of a native spreadsheet and text in spreadsheets to have the full editing power of word processing software and images in either to have access to the full image editing power of the best image editing software. Every element of a document such as text, numbers, images, video, etc. can invoke one or more form of Expanded Information, such as—a View, a Report, a document, website, etc. Expand Information includes educational materials on selected elements. The educational module also provides means to record, analyze and distribute the educational experiences of the user.

### DESCRIPTION OF DRAWINGS

FIG. 1 illustrates an example of Views, though in the interest of clarity, it is not intended to be exhaustive. A View is typically referred to by its SD. DO 1110 comprises its DOB which is all of 1110, except for DO 1110's Views 1210, 1310 and 1410. Only the part of each View 1210, 1310 and 1410 that is visible in DO 1110 is shown. View 1410's DO has visible Views 1420 and 1430. View 1420's DO has partially visible View 1425. View 1430's DO has fully visible View 1432 and partially visible Views 1433.

DO 1110 is larger (in its current scaling) than can be displayed on display 1710. Display 1710 can be considered as an SD in the DO that comprises all of the DOs currently displayed.

FIG. 2 illustrates a simple example of the use of DTAs.

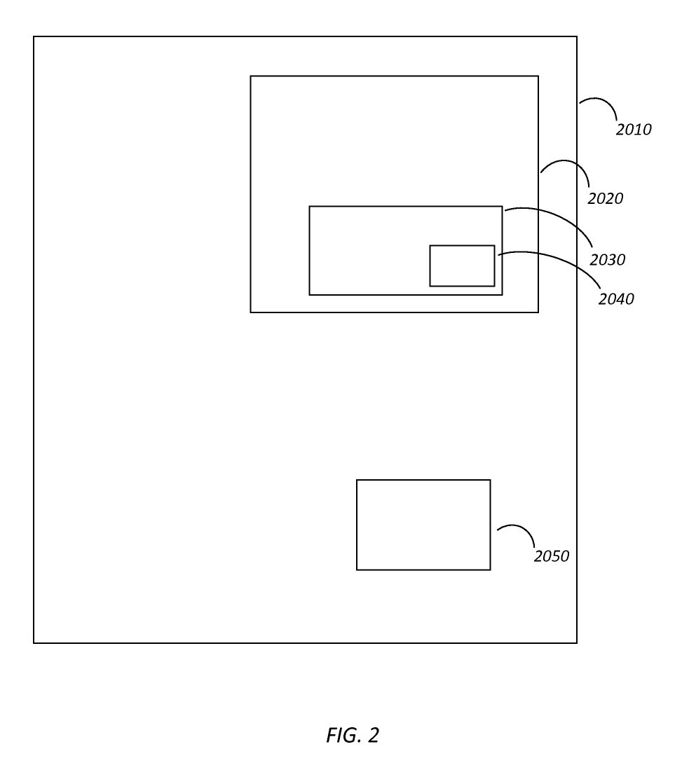

Document 2010 has Text DOB. In 2010 is Slideshow DTA 2020 and View DTA 2050. In DO 2020 is DO 2030 with an Image DTA. In DO 2030 is Text DTA 2040.

FIGS. 3 and 4 illustrate the Views Education Environment.

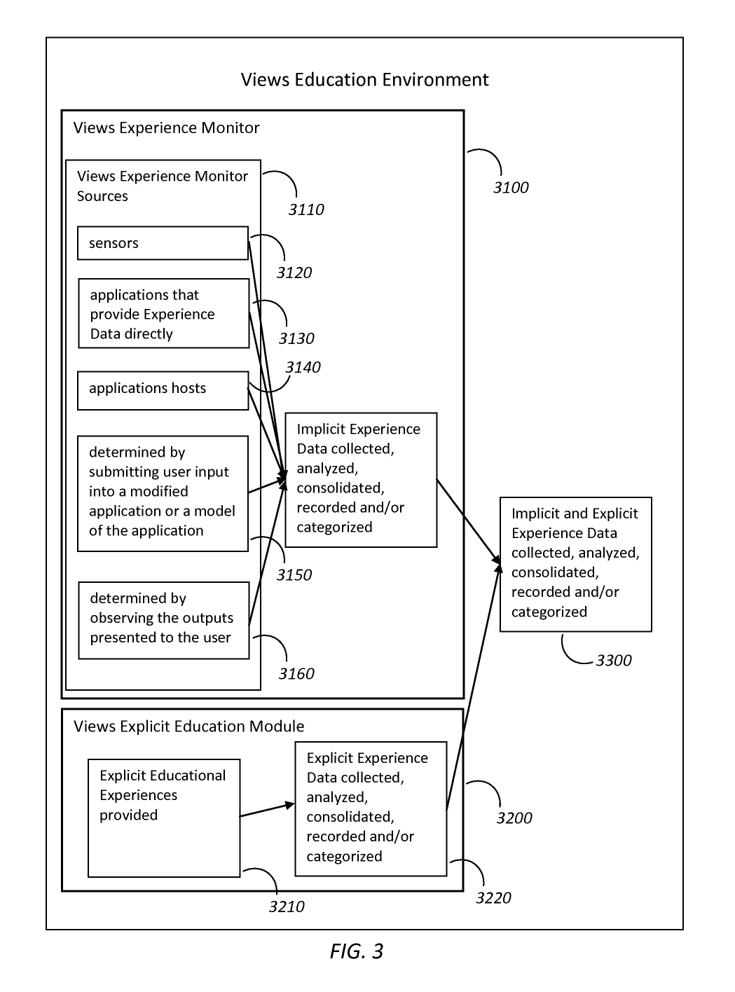

FIG. 3 illustrates how User Experience Data is collected in the Views Education Environment.

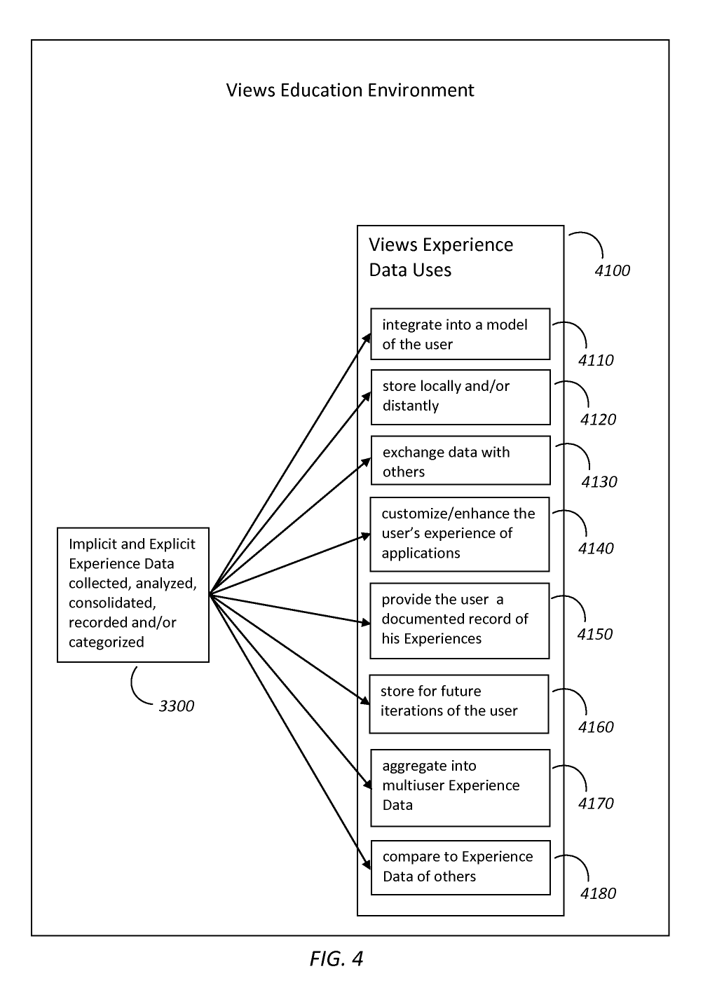

The Views Experience Monitor (VEM) 3100 collects data about a user's implicit experiences using one or more or a combination of techniques, such as 3110, 3120, 3130, 3140, 3150 and 3160.

As illustrated by 3120, the VEM can get User Experience Data from sensors.

As illustrated by 3140, The VEM can acquire User Experience Data from those who host applications.

As illustrated by 3150, The VEM can derive User Experience Data by observing and/or receiving observed user input to an application and applying that input to a copy, a modified copy, or a model of the application to determine the user's interactions with the application.

As illustrated by 3160, the VEM can observe and/or receive observed application output and/or output data to determine what the user is experiencing.

The Views Experience Explicit Education Module 3200 collects data about a user's explicit educational experiences.

Explicit Educational Experiences are provided by 3210 and the Explicit Experience Data collected analyzed, consolidated recorded and/or categorized by 3220.

As illustrated by 3300, the VEM brings together Implicit and Explicit Experience Data and can consolidate and/or categorize and record the raw and/or categorized data from multiple applications and/or multiple devices to create a deep record of the user's experiences.

FIG. 4 illustrates the VEE and some of the potential uses for a User's Experience Data 4100. As illustrated by 3300, User Experience Data can comprise the raw data, the consolidated data, categorized data, analyzed data, and data derived from any combination of these.

As illustrated by 4110, User Experience Data can be used to build a model of the user.

As illustrated by 4120, User Experience Data can be stored locally and/or remotely.

As illustrated by 4130, User Experience Data can be exchanged with others.

As illustrated by 4140, User Experience Data can be used to enhance and/or customize the operation of applications.

As illustrated by 4150, VEE can create a well documented record of a User's Experiences.

As illustrated by 4160, the full record of User Experience Data can be preserved for future iterations of the user to learn about his prior iterations.

As illustrated by 4170, User Experience Data from multiple users can be aggregated to model social systems comprising the users.

As illustrated by 4180, User Experience Data from one individual or subset of individuals can be compared to analogous User Experience Data from another individual or subset of individuals.

### DETAILED DESCRIPTION

These improvements represent a powerful invention by making the production, editing, viewing general use of information very easy to use, very easy to implement and much more useful than conventional software. The invention is named for its flagship feature, the “TransDocument View” (View) and the environment that supports it and related features—the TransDocument View Environment (TDVE). TDVE applications significantly expedite the accomplishment of conventional tasks and provide developers and users numerous useful capabilities unavailable in conventional applications, both of which greatly increasing the productivity of developers and users. The TDVE makes it easy for users to develop documents that have very sophisticated capabilities.

The TDVE can produce traditional documents and applications. More importantly, the TDVE is an environment. When a user is in a TDVE-based Document (TDoc), it is easy to incorporate complex code and perform operating system operations. The TDVE can serve as an omnipresent environment above traditional IT products in that from any part of the TDVE, such as, a document, an application, a programming language, an application development environment, operating system, web and other search interface, database, educational, internet of things, one can utilize any or any subset and link them all together, all under one easy to use orthogonal user interface.

In a TDoc, for every element that is presented, when selected, TDVE-based applications provide more information about (or associated with) that element and/or provides means for easily accessing more information about (or associated with) that element. Thus, every element that is presented is, or can be made into, an implicit representation of more information about (or associated with) that element. Additionally, every element of that additional information itself (and for every level below that), in turn is, or can be, made into an implicit representation of more information about (or associated with) that element (providing it is also a TDoc). In this document, “element” refers to any subset or combination of subsets (including Boolean combination of non-contiguous subsets) of a Displayable Object (DO—defined below). In this document, the term “subset” can include the entire set and/or all proper subsets.

In Views, every element, even every single letter, is presumed to represent, and can point to, more information regarding that element. Every text element is linked to one or more form of Expanded Information, such as—a View, a Report, a document, website, etc. For example, if a user selects the word “iron”, a Report is returned with “iron” in its different contexts, including (but not limited to), a dictionary description, its square from the Periodic Table of the Elements, a View to an education in the Chemistry of iron and to Chemistry in general, iron as a metaphor for strength, the Iron Age, images and video clarifying each of the meanings of “iron”, etc. Note also that because a Report is itself a TDoc, each element of the Report points to more information on that element, e.g. the “iron” square from the Periodic Table is a View allowing easy access to the entire Periodic Table.

For example, in a TDoc the current amount of the Gross Domestic Product (GDP) can be displayed. That amount can be current and constantly changing as the estimated GDP changes in another document (e.g. a Federal Government website). This GDP value is in a View. Like a hyperlink, a View refers to another document. Unlike a hyperlink, a View can display a specific subset of the document it is linked to. Selecting the amount, the View's Cover provides numerous options. The Cover can convert the amount to a different currency. The user can select the amount and view the spreadsheet where the GDP resides and the sum of various other numbers in that spreadsheet. If that spreadsheet is a TDoc, each of those numbers can be a View which when selected reveals a spreadsheet of other more detailed numbers and/or text or a video describing how they are derived. The Cover will offer the user information regarding jobs related to this information and will offer the user the opportunity to gain the specific expertise necessary for each of those jobs or to be educated on the economics behind each number, or economics in general.

Expanded Information

When an element in a TDoc is selected, the TDoc can enter a different mode. That mode can open a processing module and/or can provide more information called “Expanded Information” (EI). Alternatively, there are numerous ways by those knowledgeable in the current art to implement EI in software not otherwise intended to support EI. For example, EI can be implemented as plug-ins and/or add-ons in products such as those in Microsoft Office, the Google Drive office suite (Docs, Sheets, Slides, Forms, Drawings, Tables, etc) and the Adobe products, etc. EI can be implemented in local computer based and/or cloud-based applications. EI can be implemented as an app in various browsers. EI can be located locally and/or remotely.

EI can include, but is not limited to, one or more of: a View, a Report, conventional search engine results, an expanded outline, expanded text, a tour of a LearningWorks, and more. EI can be embedded in, or with, the document containing the element. EI can be statically, dynamically, and/or “hyperlinked” to that document. TDVE modules (such as DTMs) and EI, such as “hyperlinked” EI, can be on any device, located anywhere where it is accessible, such as the user's device, a local network, the internet, the cloud, etc.

For example, when a TDoc user selects a text element, the TDoc can reveal more information about, or associated with, said selected element. That EI can be a TDoc. When selected, the TDoc can display those one or more of the documents that the selected element came from, typically with that element highlighted or in some other way made easy to see. The user then can peruse and/or edit said document(s) using the full power of the text processing software used to create said document(s), even though the DOB where the user found the element might be a spreadsheet, slide presentation, image, or other type. That EI can include the results of a conventional, or other, search on said element. That EI can include a Report on the text element or another form of EI.

The EI can relate to any feature(s) of the selected element, e.g. its context and/or formatting parameters. The EI can include a list of objects associated with that element. The EI can contain ads for sponsors.

The user can use the EI for whatever purpose desired, including altering the element's content, formatting parameters, etc. When done, the user exits that mode and returns to the location and mode where he/she was before selecting the element.

The EI can be educational or training environment to provide the user the opportunity for explicit education on a topic in VEE.

EI can be notes or comments on the contents and/or formatting, for example.

Multiple SDs in a single DO can access the same EI. Multiple SDs in multiple DOs can access the same EI. Multiple users anywhere on the internet can (with the right permissions) access the same EI.

The inverse process of EI is Hiding Information (HI). Information can be marked such that it can be hidden based upon some trigger. Here the element is made into an EI and its EI's Display Flag is set to “OFF”.

Element Updates

When an element is a subset of its EI or comes from that EI, that element might change as its source changes. A TDoc provides means whereby that element in the first DO can be kept unchanged, automatically updated whenever it changes in its source, whenever it changes by some fixed amount or percentage, and/or updated based on some other algorithm. A TDoc permits the user to allow or disallow some, or all, updates to the element and can keep a record of all changes of that element, so that the state of the document at a given time can be reconstructed or its state at a future time can be predicted.

2 Dimensional TDocs

There are at least two major types of TDocs, those designed primarily for presentation on 2D displays and/or 2D printers and those designed primarily for presentation on 3D “displays” and/or 3D printers.

A simple 2-dimensional TDoc (2DD) can look like a conventional docx or PDF document. However, 2DDs are far more useful.

The TDVE represents a way to easily create, edit and display a displayable space from multiple data/information objects.

In TDocs, a Displayable Object (DO) comprises its Displayable Object Base (DOB) and zero or more Differently Treated Areas (DTAs). “Displayable” refers to the ability of data/information of a TDoc Data Type to be presented. To “present” data/information is to make a representation of said data/information that is compatible as input to its target display. A TDoc Data Type (TDT) may be presented visually, audibly, or via any other sense, direct and/or indirect neural stimulation, and/or by any other form perceivable and/or processable by a human, sensor, machine, device and/or animal.

One type of DTA is a View. Each View in a first DO comprises a “Subset Designator” (SD) and a second DO. Subset Designators are described in greater detail elsewhere herein. The subset designated by the SD might be the entire said second DO. A View's SD maps a subset of said second DO's into said first DO, said subset of said second DO is then treated like an element of said first DO. A View is like a wormhole from one DO to another DO.

There are useful situations where said SD is moved to a different location in said first DO while the designated subset of the second DO stays constant. Multiple SDs in one or more said first DOs can designate the same subset of the same said second DO. SDs in one or more said first DOs can designate different subsets of the same said second DO. SDs in one or more said first DOs can designate subsets of different said second DOs. Said second DO can be the same DO as said first DO. Any combination is possible in Views.

Any subset of any DO can be displayed on one or more displays at a time. Different subsets of any DO can be displayed on one or more displays at a time. Overlapping subsets of any DO can be displayed on one or more displays at a time. Said displays can be local or distant with respect to one another.

Data Type Module Orthogonality

The TDVE has one module optimized for each TDVE Data Type (TDT). Each Data Type Module (DTM) is used only for its single TDT. This allows each DTM to be simpler, smaller, faster and more powerful than in conventional software. This also permits the creation, editing, navigation, manipulation, etc. of each TDT to have the same functionality and user interface in every part of a TDoc.

Because each DOB has one TDT and thus can be processed by a single DTM, this orthogonality is practical. Other data types in that DO are DTAs of said DO. Thus, while a text “image” of a number can be stored in a text DOB, when that number is selected, it will be formatted and manipulated as a number (Excel, for example, has many ways to format numbers, whereas Word does not), or a subset of a spreadsheet, etc. TDVE can support the full range of current data types. Because different TDTs are processed independently, it will be easy to seamlessly add new TDTs to a TDVE-based product. This approach encourages the proliferation of specific data types, allowing greater functionality, i.e. “numbers with units”, discussed elsewhere herein.

Different image file types including (but not limited to) formats such as GIF, JPG, TIFF can have different DTMs.

Formatting information for EIs can be stored in DTAs or separate file(s).

TransDocument Views Examples

If a user is in a DO with a text DOB (or anywhere else) and selects a number (or table, etc) that is a View whose DOB is a spreadsheet, that spreadsheet is automatically opened in a spreadsheet processing module. Said spreadsheet module (the DTM-SPS, the Data Type Module-Spreadsheet) is used to process all spreadsheets in the TDVE. As such, whenever a Views user manipulates a spreadsheet, said user will always see the same user interface and have maximum spreadsheet processing functionality. If the number is not actually a part of a spreadsheet, the user has the option to build a spreadsheet based on that number using the DTM-SPS.

While in the DTM-SPS, if the user selects a text DTA, a TDoc opens the DTM-TXT (Data Type Module-Text) with the selected text in it. If said text is part of a View, that View's DO is opened in the DTM-TXT. That DO might contain a DTA that is a video. Selecting that video opens that video in the DTM-VID (the video processing DTM). Now the user has full access to video viewing, creation, editing, etc. via that DTM-VID. There is no limit to the depth of Views or other EI, that is, that each View (or other EI) that is opened can have an unlimited number levels of Views (or other EI) below it.

This module orthogonality applies to all combinations of TDTs.

Subset Designator

In general, a Subset Designator designates a subspace, in said first DO that is treated differently from the DOB of said first DO. Said subspace can be an element of said first DO or an area, often fixed, in said first DO. Thus, an SD can be provided for any EI.

In a View, a Subset Designator designates a subspace in said first DO in which a subset of said second DO can be displayed. Said subspace of said second DO can be an element of said first DO or an area, often fixed, in said first DO.

For example, an SD can designate an area in a string of text in said first DO. The EI can be text, a number, an image, etc. As the text flows during editing, the SD can flow with it. Likewise, if the said second DO is edited, most likely, the user will want the SD to maintain the previously designated text.

The only mandatory property of a Subset Designator (SD) is its ability to designate a subset of said first DO or in a View to also designate a subset of said second DO.

As an SD is created, it is assigned a unique (at least to this DO) ID. As all DOs have IDs, a given SD can be designated by its DO_ID.SD_ID.

Optional SD Properties

An SD may have other optional properties. These optional properties can be entirely variable in space, time, and/or manifest, in part, from the operation of a trigger.

One SD can overlap another SD in whole, in part, or not at all.

TDVE has a mode where all displayable SDs in a DO are highlighted or otherwise made visible.

Banner or other Software Controls

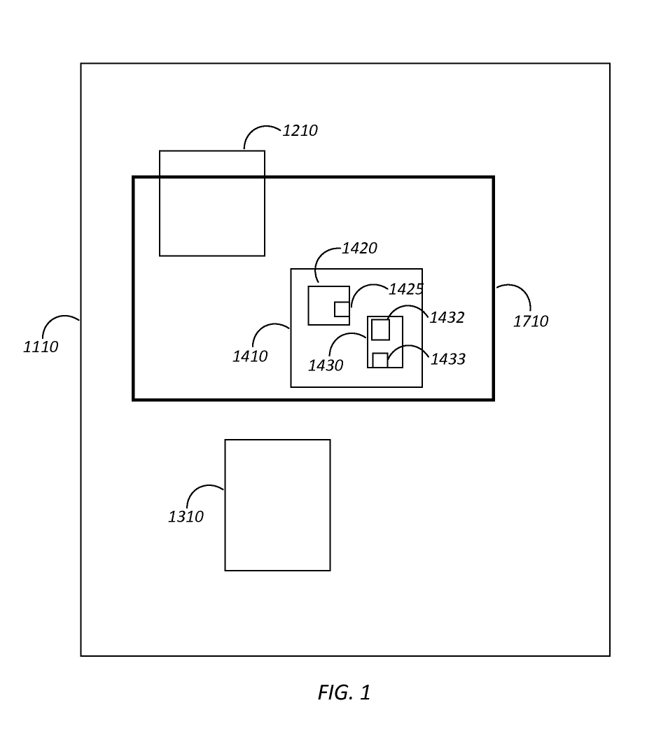

FIG. 1 illustrates Banner 1120 which can be a banner of controls for the processor for the data type for 1110's DOB and Banner 1320 which is a banner of controls for the processor for the data type for 1310's DOB. While the illustrated Banners are shown at the top or bottom of their respective SDs, it is to be understood that they can be located anywhere, including, but not limited to, for example the outside of the SD (e.g. 1320 could be where 1120 is).

Border

An SD may have a “visible” Border or one that is not “visible”. The visibility or degree thereof of an SD Border can be fixed or potentially changeable by the developer, the user, or automatically by software. The SD outlines shown for the Views in FIG. 1 represent their respective Borders. That Border represents the limits of the area of display said second DO within said first DO. The outlines shown for the Views in FIG. 1 represent their respective Borders. The Borders can be designated by a line, dashed line, and/or some other pattern, etc as seen in other products that designate particular subareas. Also, a Border might have no visible designation, such that said subset of said second DO blends with and appears to be just another part of said first DO.

Border Shape—The SDs illustrated in FIG. 1 all have rectangular Borders. As with all Border properties, the SD's Border shape is entirely variable in space, time, and/or based upon a trigger. For example, an SD Border could be defined by the outline of an image or some other geometric shape.

Border Mobility—The user or an algorithm can rotate, translate, reflect, and/or scale the entire Border and/or individual parts of a Border to reveal or conceal various parts of said second DO.

Covers

An SD can have an optional Cover. Said first DO can support Cover functions. Likewise, the EI can support Cover functions. When an SD is selected, said SD's Cover can provide the user with options regarding what can be done next in the SD.

In a touchscreen-based system, for example, a single tap on a Cover can be used to select the Cover. A double tap can be used to deselect that Cover.

A Cover can be an icon of an app, all of which is accessible from any TDoc.

The implementation of Covers can be in an environment specifically intended to support Covers, i.e. TDVE.

There are numerous ways by those knowledgeable in the current art to implement Covers in software not otherwise intended to support Covers. For example, Covers can be implemented as plug-ins and/or add-ons in the products of Microsoft Office, the Google Drive office suite (Docs, Sheets, Slides, Forms, Drawings, Tables, etc) and the Adobe products, etc. Covers can be implemented in local computer based and/or cloud-based applications. Covers can be implemented as an app in various browsers.

Cover Menu

The Cover Menu provides a list of actions that the user can take once access has been achieved. Said Cover Menu might vary from user to user as different users might have different available options.

Cover Menu Location Examples:

1. All or part of the Cover Menu can be displayed as all or part of the Cover's unopened appearance in said first DO.

2. Selecting the Cover can cause the Cover Menu to appear in a PEI.

3. The DTM for the EI can be activated and Cover Menu can be a part of the EI.

Access Control

An SD's Cover can control access to any combination of its EI's properties. Examples (including, but not limited to):
1. Security
   a. Manage access
      i. The Cover can automatically check for a password or ask the user to enter one.
      ii. User authentication and permissions relevant to this Cover's EI can inherit from the application that accessed it.
   b. Monitor access
   The Cover can monitor what information the user accesses. If the user attempts to access information that the user “shouldn't” access, this information can be transmitted in real-time to the proper channel. This monitor can look for variations from standard access paths to identify potential people with stolen access information or improper behavior on the part of otherwise authorized users of this system. The more that access is done through Covers, the more that monitoring can be done. The security monitor function of a Cover can automatically or under the control of network security personnel can redirect the user to fake data to let them think that they are achieving an improper result while the network security investigates the intrusion to determine its source and possibly employ counter-measure responses.
2. A means to collect payment for access
   a. The Cover can automatically collect a fee or first ask the user if they are willing to pay for access.
   b. This can be useful in implementing Freemium apps.
3. Named Paths
A Cover can store passwords and dialog necessary for a user to access a particular location in an application (a TDVE application or another application).
   a. For example, a user who wants to easily and automatically access his current balance from a given checking, credit card, or other account at any time can:
      i. Select from any location in a Cover-supported document and activate Cover
      ii. Select “Create Named Path”
      iii. After “Enter Path Name”, the user enters the name of the path
      iv. The user initiates the program that accesses his bank account, enters the appropriate info when prompted by the banking application, navigates to where his balance is displayed.
      v. User indicates to the Cover that the named path is complete.
      vi. User provides information about the appearance of the Cover. The appearance might be, for example, the name of the path (e.g. “MegaBank Balance”), MegaBank's standard, or just the value of the balance.
      vii. Thereafter, whenever the user wants to know his current balance, he can select this View and the current balance will automatically be displayed. Alternatively, as described elsewhere herein, the balance can always be displayed and intermittently or constantly updated.
      viii. TDVE makes it easy to build a 2D array of these account balances for multiple accounts and makes it easy to create field that displays a total of some or all of them using TDVE DTM-SPS.
   b. Once the commercialization of TDVE becomes commonplace, organizations like banks will provide an interface directly to Named Paths so that storing the Dialog will not be necessary.
4. The Cover can provide selective access. Depending upon the specific permissions of a given user and/or user's title, the Cover can determine and control, for example:
   a. Which parts (if any) of the EI can be navigated
   b. Which parts (if any) of the EI can be edited, etc.
   c. Which External View Operations are available to this user/title.

User Protection

The Cover at the user's end can help to protect the user. It can verify that the EI is authentic and undamaged. The Cover can scan the EI for viruses, etc before opening it.

Cover Appearance

The Cover can have an image in the SD: to make clear the fact that it is a Cover; to identify the contents it represents; to indicate the permissions required to access the material; to indicate that there is a cost associated with accessing it and/or to specify that cost; a logo; and/or a thumbnail of the EI, and/or to provide other information about its EI. From the previous sentence, it is clear that a Cover's Appearance can be different to different users. One example of an EI Cover can be the icon of an app.

The Cover can be opaque; to prevent an unauthorized observation of the View's DO or other EI. The Cover can be at least partially transparent. The Cover can be clear. The image can include a QR, a LOID, or some other machine-readable image etc.

Translation and Transformation

The Cover can automatically, or based on user preference, alter the EI based upon: the identity or title of the user; the user selections for the degree of detail desired or other user preferences; and/or triggers, etc.

The Cover can record a dialog or keystroke path to alter the contents and/or formatting of its EI via an intermediate DTM or other executable code.

The Cover can provide automatic encryption/decryption of its interaction with the EI and/or of the EI itself

If the EI is in a language different from the user's preference, the Cover can translate the EI to the user's preferred language. Likewise, the Cover can automatically translate units, such as customary units to metric or different currencies.

Depending upon the user's age or preference, the Cover can “translate” the EI to a simpler form. Depending upon parental controls, the Cover can “translate” the EI to a form acceptable to the parent's values.

The Cover can transform the name or picture of a molecular substance into a Lewis Dot Diagram, image of a Ball and Stick model and/or one showing the electron cloud and/or lone pairs. The Cover can transform the name or picture of an ionic compound into an image of the lattice of ions forming its microstructure. The Cover can transform the name or picture of a metallic compound into an image of the appropriate array of metallic cations in the sea of electrons forming its microstructure. TDVE can show the formation of these structures.

Numbers with Units

When a user selects a number with units, the Cover provides the option of going to the original document from which the number came and/or the Cover can present alternate units that the user can select and the Cover will automatically convert the value of the number in the alternate units. Views provides means for the user to temporarily convert the units and/or incorporate the new units into the document. For example, when the current units are $, if the document was produced in 1980, the Cover can convert 1980 $ to Current $, 1980 Yen, or the values of any other currency and/or commodity as of a particular time (see Element Updates). The value can be constantly changing based on the current value of a constantly changing commodity. In another example, a user can select “475.2 g of H2CO3” which Views then provides means to transform to “moles of H2CO3”, the corresponding number of particles, the volume at a given temperature and partial pressure and/or the partial pressure at a given temperature and volume. Other units include all of the metric and English units of mass. Additionally, the Cover can transform to weight on earth, other astronomical bodies or in a user specified gravitational or other field.

Automated conversion of units have been addressed in prior art. Like other prior art, Rai in application number EP20120186873, for example, teaches a method and computing device for the conversion from one unit of measure from a system of units into another unit of measure from a system of units. To help the user more deeply understand what a quantity means, Views also provides a means to convert a numerical value from a unit in a system of units to a numerical value in a “comparative” unit. Likewise, Views provides a means to convert a numerical value in a “comparative” unit to a numerical value in a unit from a system of units. Views also provides a means to convert a numerical value in a first “comparative” unit to a numerical value in a second “comparative” unit.

A “comparative” unit comprises a unit that is not a member of a system of units. An example of a comparative mass unit is the mass of a new quarter from the USA. Views provides means to convert, for example, between 39.69 grams to about 7 US quarters. Such a conversion involves a relatively stable conversion factor. Views also provides means to convert from a numerical value in USD (United States dollars) to, for example, bushels of corn in Brazil. In this case, the relative values of each fluctuate and it typically will be necessary for Views to look up the relative values of each on the web to make the conversion.

Units conversions can be provided in Views by accessing the Cover. As mentioned above, units conversion is an example of EI and can be implemented as plug-ins and/or add-ons in products such as those in Microsoft Office, the Google Drive office suite (Docs, Sheets, Slides, Forms, Drawings, Tables, etc) and the Adobe products, etc. EI can be implemented in local computer based and/or cloud-based applications. EI can be implemented as an app in various browsers.

Dates

When a user selects a date, the Cover offers several options, such as: determine the day of the week; convert the date to pre-Gregorian Calendar, Jewish Calendar, Chinese Calendar, Mayan Calendar, etc.

Locking

The Cover can lock elements of the formatting and/or content of the EI. The user and/or developer can lock the font, color, size, etc of the EI. When a global change is made to any of these format elements in the DOB, it is not made in that SD's contents.

Information about the EI

A Cover can provide information about its EI, such as: a thumbnail of said EI; a map of said EI; a Summary of said EI; a Table of Contents of said EI; an Index of said EI; Bibliographic information regarding said DO; a schematic of said EI. Selecting a subset of one of these can take the user to a specific location or subset of said DO.

A Cover can provide information regarding the authorship, date of creation, the EI_ID, etc of its EI.

Alternate EIs

The Cover can be used to select which of Alternate EIs (contents and/or format) to use or which version of a given EI to use. Responsive to a trigger or configuration of triggers, the code sets the Display Flag in the Cover Table to “ON” for those alternate EI's to be displayed and “OFF” for those EI's not to be displayed.

Likewise, the TDVE makes it easy for the user to define configurations of Cover Table Formatting Flags to be set based upon a specified trigger or configuration of triggers.

EI ID

Any EI can have an ID, potentially a unique ID. Thus, an EI can be accessed by its ID from anywhere, given proper permissions. This has numerous uses including (but not limited to) billing, access permissions, creator attribution, automatic traversal, and VDT structures. The EI ID can be electronically readable and/or visual such as a QR or LOID.

External View Operations

From said first DO, a user can alter the subarea of said second DO that is visible in a View's SD, with the permission of that View's Cover. The user can perform operations (including, but not limited to) such as a rotate, translate, reflect, and/or scale the image of that View's DO relative to that View's Border. For example, in a touchscreen supported system, when a user touches inside of the View's Border with two fingers, he can easily scale the image of said second DO up by moving the fingers apart, scale it down by moving them closer to one another, reflect said second DO by moving two fingers together then beyond one another, rotate said second DO by rotating his wrist causing the contact points of the fingers to rotate, or spatially translate said second DO in any direction by swiping it with one or two fingers in the desired direction. It might be necessary to require two fingers inside the View's Border for a DO spatial translation to distinguish it from a spatial translation of said first DO. One use of External View Operations is to size and position desired content from the second DO in the View's SD.

With the proper permissions, the user can alter contents of the second DO.

Pop-up EI (PEI)

A Pop-Up Expanded Information is EI whose presentation changes when a trigger or combination of triggers occurs. Changes in presentation can include, but are not limited to: PEI appears over said first DO when it was not there before; PEI can be inserted into the DOB; PEI changes in size, shape, color, intensity, transparency, flashing, etc; and/or PEI emits sound and/or changes the nature of the sound that it is already emitting. These changes in presentation can cease or switch to different changes in presentation when a trigger or combination of triggers occurs. A PEI that remains significantly after it appears is a Persistent PEI. A Flag in the EI's Cover Table determines each formatting element of the EI's content including whether or not the EI is displayed.

Structured PEI

Subsets of a DOB can be contracted and/or expanded. Expansion can be implemented via PEI. Contraction can be implemented via “hiding” that PEI, setting the Display Flag in the PEI's Cover Table to “OFF”. PEIs can include PEIs, so expansion can be done over multiple levels. Likewise, the corresponding contraction can be done over multiple levels.

For example, in an Outline, every part of the outline structure “number” can be an implicit Cover for more detail for that “number”, more detail as in more detailed outline under that “number” or a more detailed description of that “number”. This permits an outline structure to be contracted and/or expanded. This makes the preparation and management of a complex outline much simpler.

For example, in Text, subsets of a document, typically subordinate subsets, can be contracted or hidden to show the logical flow or a higher order perspective of subsets of the document. The author and/or user can contract desired subsets when less detail is desired and expand one or more when the greater detail is desired. This material can have a Cover in order to provide the properties that a Cover confers.

For example, in a spreadsheet and/or a subset thereof, the results of a calculation, for example, can be expanded to show the fields that were used in the calculation. Likewise, those calculated fields can be selected and the fields upon which they depend contracted out.

For example, a pixel or raster image can be stored in a resolution such that when viewed at 1×, it looks crisp and clear. Normally, when a user scales an image up, it becomes grainy and less of the full image's area is displayed. Before it would become grainy, a higher resolution version of at least the now-displayed subset is displayed instead. This can be scaled up even further; when that can be replaced a higher resolution version of at least the now-displayed subset becomes displayed. This process can provide a seamless scaling from the largest object to the smallest. This would typically use multiple data files representing different scaling in different locations.

Automatically Inserted EI (AIEI) is EI that is automatically inserted into the TDoc. An example of AIEI: given a chemical equation with a solvent and solute, added to the display information is the solubility curve of the specified solute in a specified solvent. If a specified temperature is provided, the specific value of the solubility is provided.

Progressive Revelation

Due to the past ways that data has been stored, information (such as writing) has been limited to presentation in a linear order. Hyperlinks provide limited variation of this. The TDVE provides means to present information in any order desired by the presenter and/or the observer of that information. One example is Progressive Revelation, is the process of revealing information in a particular order to achieve a desired effect. Traditionally, in the telling of stories this is done by providing new information later in the sequentially presented document. As an application in Views, once the reader has read the first level of the story, the reader can ask for more and a Persistent PEI can be added to the document, marked so that it is easy to find. Once that has been read, more revelations can be presented. This can provide a new way of telling stories. Progressive Revelation can be used to create situations that appear one way, the turn out to be very different. This can be a good way to teach people about the hazards of preconceived notions. Also, the author can add more information in any location over time, resulting in a story of potentially unlimited length. Here the EI Display flags are turned on based on the author's algorithm, often as the result of a specific trigger.

TDVE frees authors from the constraints of traditional linear presentation of stories that are or at least can be inherently nDimensional.

Outline <=> Paragraph

TDVE makes it easy for the user to switch back and forth between an outline mode and a paragraph mode. When composing a document, it is often useful to first create an outline of the contents to organize the information before turning it to prose and removing the outline numbering, indents, etc. Once the outline structure is removed, it is harder to determine the best place to add new material. In TDVE, when the user is ready to turn the text to paragraph mode, he does not delete the outline numbers and indents. When he wants the outline numbers and indents gone, he switches to paragraph mode and TDVE does not display them, only the paragraph structure. When the user wants to, for example, add new material or rearrange the contents, the user can switch this section of text back to outline mode and TDVE expresses the outline mode with the saved outline numbering and indents. Likewise, in TDVE, the user can take text already in paragraph mode, save that paragraph formatting information, and the user can make an outline of it, and later return to the saved paragraph formatting mode. The user can switch back and forth between modes without limit. A module in Reports will be able to automatically convert text in paragraph mode to outline mode.

VDT Structures

A user can use TDVE to easy build and manage complex VDT structures. For example, a VDT-TXT DOB is essentially a linear array of 2D arrays (maps into a series of pages) of formatted (wrap, paragraphs, etc) 1D arrays of strings of elements. In Views, any combination of those elements can be DTAs. Thus, in Views, it is easy to make a linear array of images or spreadsheets or any other VDT or any combination of VDTs. Likewise, in Views a spreadsheet can be a linear array (workbook) of 2D arrays (worksheets) of 2D arrays of elements. In Views, any combination of those elements can occupy DTAs. Thus, in Views, it is easy to make 2D arrays of images or spreadsheets or any other VDT or any combination of VDTs. Note, that spreadsheets in Views can be 3D, 4D or nD arrays of elements. Views will make it easy to build any type of structure in which any combination of VDTs can be organized.

For example, a Periodic Table can be created using the 2D array capabilities in DTM-SPS. As is typical in a Periodic Table, each element is represented by an image with information about the element (its symbol, name, atomic number, atomic mass, etc). In Calculator Mode, however, each element image is also a button of a calculator. The calculator also has a button for each polyatomic ion. The calculator has a button representing each digit. The calculator provides for the easy computation of molar masses for chemical compounds. The user presses the button for a given element, then the number of atoms of that element, then the next element's button, then the number of atoms for that atom, etc. until the compound's formula is entered. Alternatively, the user can enter the compound's formula by entering, for example, “Ba(OH)2” to designate Ba(OH)2. To enter chemical equations, the user can enter “N2g+3H2gy2NH3g”, where “y” (or “−>” represents the “yields” key, translates as “N2(g)+3H2(g)→2NH3(g)”. There will also be keys for “reverse reaction” and “equilibrium reaction”. The compound's formula and molar mass can be updated with each entry. This tool can be a part of a larger tool that helps to balance equations and automate other stoichiometric operations.

Triggers

A trigger is software and/or hardware based. When a pre-specified event or type of event occurs, one or more triggers can be activated and/or deactivated. A trigger can cause one or more events to occur and/or cause one or more other events to not occur. An “event” in this context can refer to a configuration of events. The TDVE supports the easy creation of triggers, the easy linkage of events that activate triggers and the easy linkage of triggers to the events they cause. A trigger can be caused by, and/or can cause, changes occurring in any content and/or formatting of any data and/or a set of data and/or configuration of data and/or any other structure or feature in the TDVE. A trigger can cause and/or be caused by a start, stop or an alteration in the functioning of a DTM. A trigger can be caused by any event or configuration of events knowable to a TDVE-based embodiment. A trigger can cause any event or configuration of events actionable by a TDVE-based embodiment.

For example, a trigger can be activated and/or deactivated by:

a. selecting an SD or other EI

b. a particular time or elapsed time

c. the spatial and/or temporal “summation” (including other algorithms) of other triggers and/or another configuration of trigger states. Triggers can inhibit other triggers.

d. a change in an image from a video camera and/or other sensors

e. a particular combination of keystrokes or other user input

f. the location of a user

If on a mobile device, TDVE-based applications can monitor its location. Being at a particular location and/or orientation can trigger an event. For example, the user's mobile device determines that it is near a Whole Foods, this can trigger the mobile device to notify the user of that fact, such that the user can chose, for example, to display a shopping list. See the Pointing and Identification Device patent application for more information on this. If a TDVE-based application is on any device and Views determines that one of its users is at, or near, a given location, that can be a trigger.

g. Another event, such as the receipt of any email or an email from a specified entity, the receipt of a package, etc.

h. TDVE Templates make it easy to define linear and circular sequences as well as other algorithms of setting triggers.

In business and other situations in life, it is important to make sure that certain events have occurred by a given time. For example, a user has ordered a product. The product is expected by a specified date. When the order is created, Views can automatically create a trigger that, after the expected delivery time, asks the user if the product has been received or causes some other actions to occur. The user has the option to enter (manually or automatically) the receipt of the product when it arises. This would prevent that trigger from activating. In this way, Views-based triggers can help individuals and businesses to manage a multiplicity of transactions and event trees.

A trigger can generate of an efferent event

a. One or more triggers can cause the opening and/or the closing of one or more PEIs.

b. For example, a deposit, withdrawal, or expense in a bank or credit card account, or a type of withdrawal or expense greater than a certain amount can be a trigger. The bank can ask for the user authorization to make the payment by causing a PEI to display on the display in use by the user. If none is in use, a TDVE-based application can send a text or automated call to the user.

c. Any selection of any element can trigger an information collection event by a TDVE-based application about what the user has selected and provide that information to an information collection organization.

d. A trigger can cause data in a TDVE-based application or other EI to be updated.

That event can also mark that data to show that it has changed. A change history tracking all changes in data can be maintained.

Reports

TDVE-based applications can create a Report based on any VDT. A Report can be a Previously Prepared Report (PPR) or an On-Demand Report (ODR) prepared when the element is selected. PPRs can be standardized by the producers of the Views software, or by others. PPRs and ODRs can be produced manually by people or automatically by software. Reports can be edited by the user and saved as a PPR.

A search on a letter is likely to be a PPR. A Boolean search on a set of phrases might be a PPR or an ODR. A word can be selected, or a phrase, or a sentence, or a Boolean combination of these, etc. Likewise the user can initiate a search on an image or any subset thereof. A subset of the results of that search can be stored as a View. TDVE-based applications can synthesize a Report from the results of a conventional internet search.

Report Sponsors

All EI, including Reports can have a section with one or more ads. Such ads can include ads paid by sponsors. For example, sponsors can have a dedicated area in the Report for that given letter, word, and/or phrase, image, video, etc.

Income from Sponsored Reports can help fund the development of, the maintenance of, and revenue for Views software. Some Reports will have one-time payment sponsors. Others will have per click sponsors. Some will have temporary sponsors determined by auction or other means.

A list of objects associated with that element can be a part of a Report.

Blogs

A Report can return internal or external blogs or sites discussing the user's selected topic. Views makes it easy display a 1D or 2D array of blogs from different sites simultaneously updated so that the user can keep up with a large number of blogs simultaneously. The user can select the one he wants to enter and make his comments, exit, and go back to monitoring the array of blogs. This makes it easy for the user to find out what others are saying and to express his opinions in a broad range of blogs or discussion sites. Views Reports will bring together diverse communities discussing a given topic. This greatly lowers the threshold for users to find and participate in such blogs or discussions. This will encourage users to use Reports.

Likewise, it will be useful for Views to host multimedia forums on topics of high interest. Users can present Views-based documents in these forums.

Text Subtypes in Reports

A specific Text Subtype can return Report specific to that Text Subtype.

When an element of a bibliography (reference to a book, periodical, webpage, etc.) is selected, Views can display the referenced document at the location of a quote, if given, and the user can (with the proper permissions) then peruse and/or edit said document. Optionally, information on how to purchase that document can be provided.

When a person's name is selected, Views can provide a standardized Person Report on that person, with person-specific information, such as contact information, biographical information, his or her social media pages, publications, patents or works of art they have created, etc.

When an ambiguous name like, “Bethesda” is selected, Views can provide a standardized Ambiguous Name Report, with information such as, a list of places called “Bethesda”, references to “Bethesda” in literature.

When a more specific name like, “Bethesda, MD” is selected or if Views can determine from the context, or user interrogation, Views can provide a standardized Place Name Report with categories of information about or associated with Bethesda, MD, such as, history, maps, pictures, literary references, info on restaurants and other businesses there, etc.

When the name of a company is selected, Views can provide a standardized Company Report providing the types of information generally desired regarding companies.

When a miscellaneous noun, pronoun, verb, adverb, adjective, or other word type not specified elsewhere is selected, Views can provide a standardized Report on that word, typically based upon the word's type.

Image Reports

When an image is selected, TDVE-based applications can provide a Report supplying more information about or associated with that image and/or the object(s) that said image represents. Text or another image can be a subset of an image. If that subset is selected, TDVE-based applications can provide a Report about or associated with that subset.

Report Related Objects

Objects referenced in or associated with a DO or Report or other EI can be selected to connect to that object to read sensors regarding said object and/or its surroundings and/or to perform operations on, or with, said object.

All Reports and other EI can contain ads and/or information about how to easily buy said objects and/or products and/or services related to, or associated with, said object, product and/or service.

Report Standardization

Reports are standardized to make them easier to understand and use. Because of this, every time a user uses a Report, his ability to process Reports improves. In general, all Report types will be standardized regarding the features shared across Report Types. Within a given Report Type, standardization will be rigorous. There will be a uniform format for the location of particular types of information in each Report and standardized formatting of the contents. For example, an Executive Summary of the Report might always be on the first page of the Report in a standard location, in a standard font with a standard border and other standard formatting etc.

The Report will be have a structure such that the more commonly desired information is most immediate and less commonly desired information is less immediate. As a Report is a VDoc, its traversal path can be a data type and Views provides means to easily make an Object that can be automatically traversed and/or manipulated.

The purpose is to provide simple access to all available information on a topic, organized in a standardized way so that it is easy to navigate. Being a Views VDoc, each Report can be virtually unlimited in size. An example is the Object type for a person described elsewhere herein. Vast amounts of information is available about people, on many levels, including (but not limited to): biological (DNA, medical, etc.; vital statistic; sociological (via links to Facebook, etc); academic, publications, patent and other accomplishments; and many, many more.

By command of the Cover of the EI for a Report, the Report can be simplified or otherwise altered to suite a particular audience (see more under Cover). The Report can also be automatically altered to be specific to the Views software's knowledge of the instant user or based upon the user's request for a longer or shorter Report.

Miscellaneous Reports Info

For all EI, Views maintains a search history and provides access to the user, as a VDoc.

Views Education Environment (VEE)

The Views Education Environment (VEE) collects, analyzes, and distributes information regarding the educational experiences of its users. VEE comprises an educational/training environment that provides content and tools to educate and/or train the user generally and/or specifically. VEE considers all experiences to be educational, both formal educational experiences and implicit educational experiences. Part of VEE is the Views Experience Monitor that collects, analyzes, and distributes implicit educational experiences.

VEE is an example of EI. As such, VEE can be integrated into the TDVE or VEE can be implemented as plug-ins and/or add-ons in products such as those in Microsoft Office, the Google Drive office suite (Docs, Sheets, Slides, Forms, Drawings, Tables, etc) and the Adobe products, etc. EI can be implemented in local computer based and/or cloud-based applications. EI can be implemented as an app in various browsers.

Views Experience Monitor

The Views Experience Monitor can collect, analyze, and distribute a detailed profile of what the user has perused and/or created, the tools the user has used, etc. . . . all of the accessible experiences (afferent and efferent) of its users, individually and collectively. The classification of experiences can be into coarse categories or very specific skills. VEE is not limited to explicitly educational experiences. The Views Experience Monitor (VEM) can monitor and store implicit educational experiences, of its users and analyze and classify those experiences.

VEE treats every experience that is not an explicit educational experience as an implicit educational experience. All interactions between the user and his environment are considered to be educational, including, but limited to, what the user perceives and the user's actions. A user's use of eBay, for example, to buy items can be classified as a purchasing experience and an educational experience. A user's mastery of various features in eBay can illustrate the mastery of particular skills and/or concepts. To gain a more complete evaluation of the user's mastery, VEM records and compares the user's use of eBay over time and can evaluate what skills and concepts were learned and over a given time and number of uses. In this manner, VEM can determine the mastery rate and growth of the user's mastery of various skills and concepts over time.

The VEM can get User Experience Data from sensors. As users increasingly use wearable devices with cameras, microphones and/or other sensors, those sensors can provide the VEM with information about what the user is experiencing and/or his reactions to those experiences. Sensors that can capture User Experience Data can be worn by others and/or located in the user's environment. Cameras can capture data about what the user sees and microphones can capture what the user hears. Cameras can also capture what the user does and microphones can capture what the user says. A camera can observe the user's eyes, their orientation at a given time and the size of the user's pupils. This method can be used to capture user input to applications and the output produced by applications. More detailed disclosure regarding the use of sensors can be found in the Extended Perception System Provisional Patent Application by Jesse C. Bunch.

Software specifically written to support VEM's recording and classification of User Experience Data, including, educational experiences can be written to directly report those experiences, and optionally their classification, to VEM. Other software can be adapted to report User Experience Data, and optionally their classification, to VEM.

The VEM can acquire User Experience Data from those who host applications.

The VEM can monitor data input to and output from applications together or separately to collect User Experience Data without needing to go those who host applications.

The VEM can derive User Experience Data by observing and/or receiving observed user input to an application and applying that input to a copy, a modified copy, or a model of the application to determine the user's interactions with the application.

The VEM can observe and/or receive observed application output and/or output data to determine what the user is experiencing. For example, the VEM can intercept data from an application driving an output device to identify what that device is presenting to the user. This allows the VEM to collect User Experience Data for users of applications without having to buy that data.

For example, the VEM can intercept the data being fed to a display. The data is allowed to continue to the display. The VEM interprets a copy of the data as display images, the images that the user observes on any application that displays visual output, such as business software, the devices camera roll, Instagram, or Facebook. Such visual output can be for example, text, numbers, images and/or any combination thereof.

Likewise, the VEM can intercept the data being fed to a microphone. In this way, the VEM can “listen to” any application that produces audio output, such as the user's Pandora music to determine the user's musical experiences and preferences.

The VEM can “listen to” the soundtrack of a TV (or other) show and identify the show and what location in the show (time into the show) is currently being displayed. The VEM captures the soundtrack data and uploads that soundtrack data to a remote location, such as a website. That website uses software like the software that is used to recognize songs from “listening” to them, such that used by MusicID. It might be necessary to convert the data format before uploading to the website. Instead of recognizing a song, the website recognizes the soundtrack and via a database of soundtracks maps the location in the soundtrack to a specific time and therefore a specific frame or set of frames in a specific show. To best avoid ambiguity, the VEM can be constantly listening for shows.

The VEM can “listen to” or “watch” a show as described above if the show is on the same device as the VEM. Without intercepting the data going to the output device, the VEM on one device can literally, via the microphone on that device, listen to the soundtrack of a show on itself or on another device and identify the show and specific frames being viewed. Likewise, as described in the Pointing and Identification Device Patent of Jesse C. Bunch, the camera on a device can capture an image of a frame of a show and upload that to a database to determine the show and what frame it is in the show.

The identity of a show and the parts of it that the user has watched comprise User Experience Data. This and every other means described herein for determining what the user is presently experiencing or has experienced can also be used to launch EI on this experience. For example, the EI can comprise information related to buying products and/or services related to the experience. For example, when the user decides he wants to buy something related to a show he is watching, he can select that he wants EI about the show. The VEM knows what he is watching and where in the show he is, so the VEM can access EI about products and services associated with the show and/or just that part of the show from a remote database that manages the links between shows and/or parts of shows to products and services. This type of database is described in greater detail in the Pointing and Identification Device Patent. As described therein, the VEM can then display to the user a list of products and/or services associated with the show and/or just that part of the show. (The list can be text and/or images and/or other representations of that information.) The user then can select from that list what he wants more information on or what he wants to buy. The VEM can then assist with the transaction as described in the Pointing and Identification Device Patent. Alternatively, when the user decides that he wants to get EI on something in a show, he can bookmark the location and come back to it after watching the show. Whether in real-time or from a bookmark, the VEM can display the selected frame individually or within an array of frames proximal to that frame. Displaying an array of frames makes it easier for the user to find the desired frame if he did not get it exactly the first time. The VEM can display the frame on the device on which that instantiation of the VEM is running or another device. The user searches the frames by any of a number of means including scrolling through the frames or watching the show forward or backward from that point and stopping it at a close proximity to the desired frame, then searching frame by frame if necessary. Once the user has selected the correct frame, he can select from a list of available EI (e.g. products and/or services) associated with that frame (or that scene or that show) or a list of objects in that image for which EI is available. If desired, the user can select a portion of the image to expand. The selected subset of the image will have an even more limited list of available EI or list of objects for which EI is available. This process can be repeated until the desired EI is found. An alternative way to find the desired frame is to use the video searching means described elsewhere herein.

EI can comprise a scene or episode of a series that this scene refers to directly or indirectly. This permits a user to start watching a series having not seen all of the previous episodes and catch up on prior parts when he wants.

Regarding Implicit Educational Experiences, the VEM can access a database that links implicit learning experiences to specified portions of the show. Thus, the user is given the implicit educational experience credits associated with the portions of the show that he watched. Explicit credits can be given if he performs well on a test on the material presented in the parts of the show that he experienced.

The Views Explicit Educational Experiences Module is illustrated by 3200. Module 3210 provides Explicit Educational Experiences.

Explicit Educational Experiences—EEE

When a user selects an element, that user can be given several EI options. For example, the user can get a View, a Report, standard search results, other EI, or have the option to get formal training on the topic selected.

The user can learn specific material and optionally be evaluated on his expertise on that material. EEE can be as an educational tool to help with students doing their school homework. VEE can be used to obtain an entire education for home-school students, for independent study, and/or for online degree programs.

Integrated into the TDVE or an application in any operating system, EEE is an educational/training environment that provides content and tools to educate and/or train the user generally and/or specifically.

The content of specific subject matter standards, such as Common Core 2.0, International Baccalaureate (IB), or Advanced Placement (AP) can be the subjects of complete training and/or evaluation.

One EI user option is to enter EEE, the Views Education Environment. Many “lands” are in VEE representing various fields of knowledge, such as: ScienceLand with its ComputerScienceLand, PhysicsLand, ChemistryLand, BiologyLand, etc; MathLand with its AlgebraLand, GeometryLand, PreCalculusLand, CalculusLand, StatisticsLand, etc.; HistoryLand; EnglishLand; and many more fields known to academia.

One option that EEE provides to present information is to have one or more avatar(s) provide guided tours thru a Land. EEE, possibly personified by an avatar, presents multimedia educational information to the user. Such multimedia information can include lectures by the best educators in the world. If the user prefers, he can watch a lecture on the same material by a different educator. EEE can learn what learning style the user prefers and offer new material presented first in that style.

Progressive Revelation can be used to present educational material in an integrated way. Extended stories can provide a context for student involvement for solving problems.

Evaluation

In all TDVE-based applications, including VEE, all of the displays, for example, can be on a computer display, TV, tablet, wearable device, phone or other mobile device.

Regarding Explicit Educational Experiences, EEE evaluates the student for mastery of the material presented before new material is presented. The topics where weaknesses are found are presented again, perhaps in more detail or with a different approach. The student is then reevaluated. The process is repeated until mastery is attained.

As a part of the TDVE, every state is stacked so that after entering another space, the user can come out and be where he was before he went in.

The use of EI can be illustrated by its application in educational experiences. When in a video, the user can stop the video, jump to more information (perhaps another video) that explains in more detail a topic mentioned in that video. VEE can encourage this by providing explicit references to topics mentioned and links to EI on those topics. For example, the student is learning Algebra I and watching a video about “factoring trinomials”. In this video, the topic “factoring numbers” is mentioned and mastery of this topic is important to mastering the factoring of trinomials. If the student wants a refresher on factoring numbers, the student, by pressing a special key, making menu selection, or by some other means (many of which are known in the art), can select to freeze the current video and show a video (or other educational material) on “factoring numbers”, perhaps followed by an evaluation on the topic. The “factoring numbers” video mentions “prime numbers” and provides a link that the student can use to learn more about prime numbers. If selected, the “factoring numbers” video is frozen and the “prime numbers” video begins. There can be evaluation then on prime numbers. Once done learning about prime numbers, the student is returned to where he was in the video about factoring numbers. After the student is done learning about factoring numbers, he is returned to where he was in the video on factoring trinomials. This is profoundly important as a student cannot learn about factoring about trinomials without being able to factor numbers and cannot learn about factoring numbers without learning about prime numbers. Students often don't have (or have forgotten) these foundations upon which the new knowledge is built. Determining the occurrence of a link, for example, can simply be that the user clicks on the video and a list of links is provided.

A useful way to search for a location in a video one has seen at least a part of is by means of a binary search. The search starts by showing the middle of the video. If the user recognizes that the desired scene is after the currently viewed scene, the user selects “up”, taking the user to the frame ½ way between the middle and the end of the video. If the desired scene is before the middle of the video, the user selects “down”, taking the user to the frame ½ way between the beginning of the video and the middle of the video. If the desired scene is later than the current frame, selecting “up” taking the user to the frame ½ way between the current frame and the highest boundary. Ten selections divide the video into 1024 pieces. Fast sequential search forward and backward will be available. Likewise, the user can search on content such as dialog, character, events, objects, etc. in the video, including Boolean combinations of them. Binary search is available for all types of data in Views.

The VEM can consolidate and/or categorize and record the raw and/or categorized data from multiple applications and/or multiple devices to create a deep record of the user's experiences.

User Experience Data can comprise the raw data, the consolidated data, categorized data, analyzed data, and data derived from any combination of these.

The User Experience Data can be used to build a model of the user. For example, delays in responses to a given stimulus category can indicate the presence of a complex as described in the works of Carl Gustav Jung. This information can be used to present to the user a set of experiences that can help to diffuse any effects of the complex that the user doesn't want. If the User Experience Data is time stamped, it can be correlated to other coincident events. For example, the VEM can compare data regarding the orientation of the user's eyes at a given time with the information regarding what is being displayed and the orientation and location of the display at the same time to determine what the user was looking at that time. The user's pupil size and changes thereto during that time can be used to determine, for example, the degree of interest in the viewed part of the image. This data can provide significant information about the user's interests and disinterests. Time stamping of User Experience Data also provides the order of experiences. The order in which the user subconsciously chooses to observe the parts of an image can be used to model the user's method for visually processing images. The topics that the user voluntarily researches and the depth of understanding he pursues provides a lot of useful information about the user's intellectual values and expertise.

VEM's model of the user can comprise user efferent patterns, such as inputs to applications, such as patterns of speech or timing or other patterns in keystroke input. Variations in those patterns can reflect variations in the user's intellectual and/or emotional state of the user. Thus, by monitoring efferent changes, VEM can monitor the user's intellectual/emotional state and corresponding changes in that state. Certain variations in efferent patterns can indicate that an impostor is using the system. VEM can observe such situations and provide that information to the appropriate security system and/or personnel.

The VEM can use the User Experience Data to determine the user's experience with, and the degree of mastery of, software (and hardware) tools and subject matter content and the time and effort required to attain that mastery.

Videogame User Experience Data can provide substantial information about the user, such as; eye-hand coordination, strategic and tactical thought processes, and motivation under stress.

User Experience Data from a user's use of word processing software to compose documents can provide important information from for example, the user's vocabulary, word choice, sentence structures, and topics written about.

User Experience Data can be stored locally and/or remotely.

User Experience Data can be exchanged with others. Others might use that data to market goods and services to the user or try to persuade the user to vote in a particular way.

User Experience Data can be used to enhance and/or customize the operation of applications. For example, User Experience Data from many or all users can show that all users, or specific subgroups, have trouble learning to use some feature of an application. This information can be used to improve the user interface and VEE can then be used to determine the effectiveness of that experience. VEM can be used to categorize the user, for example, by learning style. This information can be automatically made available to an application, so that the application can present its data in a way most compatible with the given user type. The User Experience Data specific to a given user's use of an application can be used by applications providers to even more specifically personalize of their application to enhance each individual's user's experience of the application. At this level, the customization will be done by software.

VEE can create a well documented record of a User's Experiences. Thus, a user's relevant Experience Data (such as work-related experiences, implicit and explicit educational experiences, and character-related data) can be selectively packaged for submission to a potential employer as an automatically generated verifiable “resume”. The potential employer can search the user's full User Experience Data record(s) for whatever parameters that are appropriate and get complete data with fully detailed documentation for each relevant Experience.

The documented record of the User's Data Experienced can also provide objective exculpatory evidence for a legal proceeding.

A set of employers can (via VEE) make available to head hunters or to potential employees specific configurations of experiences that they are looking for potential positions. Potential employees can submit their User Experience Data to VEE. VEE then looks for reasonably close matches between what is wanted by the employers and the experiences of the potential employees. VEE can then inform the potential employers and/or employees of close matches and can provide a configuration of implicit and/or explicit educational experiences to each potential employee that can provide the missing required experiences and document their successful completion. VEE can more generically recommend to a potential employee specific educational experiences that would make him more desirable to generic and or specific employers in general.

Alternatively, a potential employer can be provided the anonymous (or not) employment-relevant User Experience Data of multiple potential employees to look for potential matches for their requirements. A potential employer can then request that selected potential employees gain certain prescribed experiences and testing.

The full record of User Experience Data can be preserved for future iterations of the user to learn about his prior iterations, not unlike the practice of ancient scribes recording the every action of the pharaohs.

User Experience Data from multiple users can be aggregated to model social systems comprising the users. The data collected by VEE can provide an unprecedented amount of useful information about the experiences of a user and/or groups of users. This data can be compared between different users to learn the who what, when, where, why and how of the experiences of various groups and subgroups of users.

The data collected by VEM can provide an unprecedented amount of useful information about how the experiences of a user and/or groups of users change over time. This permits the ability to automatically predict the experiences that the given user and/or group of users will want. These experiences can be offered at the time when it is predicted that they will be wanted. Configurations of User Experience Data from different users can be compared to find users that are similar in given ways.

Certain applications provide a degree of monitoring experiences and predicting desired experiences. Google's tailors its searches based upon what the user has searched before and Amazon predicts when a user will want another order of a consumable product it has sold to a user.

The TDVE as a Programming Environment

The TDVE can serve as a programming environment. The TDVE can simulate many of the traditional programming languages for the creation and manipulation of the TDVE, the VDTs and the contents of said VDTs.

Examples include the refined use of triggers and complex calculations in spreadsheets.

TDVE-based applications can interpret an automated path through a TDoc as a TDVE Object in the object-oriented programming sense of the term. A TDVE programmer can then assign operations for the algorithmic manipulation of these potentially very powerful Objects. An example of such a TDVE Object is a representation of a person. In TDVE-based applications, potentially all machine-readable information regarding an individual can be stored, accessed and processed in a standardized Object type of linked data. Potentially all individuals can have their machine-readable information in the same Object type. Access and manipulation of TDVE Objects can be done by automatic traversal of TDocs using strings of DO_IDs, SD_IDs, and EI_IDs, etc. TDVE Objects possess many attributes of a database and as such can be used to implement complex databases. Standardization and generalization of TDVE Object types can be defined for any relevant object. Examples include: countries, states, counties, cities, industries, companies, schools, other organizations, building, equipment, other objects, processes, concepts and more too numerous to mention. Specific standardized, generalized Object subtypes can include Efferent Objects and Afferent Objects. Clearly many objects can participate in multiple subtypes.

The full implementation of the TDVE can be written in a TDVE kernel which can be the machine-specific form or the kernel itself can be written in a language that runs efficiently on many platforms.

Triggers can be implemented by Trigger Tables with: the name of the trigger (or configuration of triggers) and its state. The state of the trigger need not be just “off” or “on” with 1024 or more levels, including negative values. Multiple positive levels support the implementation of summation and temporal decay or growth. This means that the value of the trigger can be decreased or increased as a function of time. Negative values permit triggers to inhibit other triggers or actions. Trigger Tables can be structured as an Outline whereby subordinate Triggers are dependent on their superior.

The constant scanning of triggers for their state can implement non-sequential programming.

TDVE-based applications provide the user with templates and/or forms and/or interactive dialog to assist non-programmers to use sophisticated TDVE-specific and typical programming data and control structures so that the user does not need to learn a special syntax. Likewise, the TDVE provides visual representations of Trigger Tables, Views Objects, and all other structures, so that the user can better understand the actual relationships and create and edit them in the visual representation mode.

Miscellaneous

Multiple users on a network or on the internet can peruse the same Views document at the same time.

A user has many options to select an element or option, including but not limited to any means available on computers, tablets, mobile devices, game devices, smart TV pointers, PID or device yet undeveloped. These include (but are not limited to): mouse, touchscreen, joystick, PID pointers, voice input, etc.

Various DOs and/or EI can exist on one or more files.

TDVE-based applications provide tools to translate from any VDT to any other VDT.

TDVE Data Types

This list is illustrative, not all inclusive.
1. Any type of data or information that can be displayed in 2D (or as a projection in 2D) can be in an SV.
2. View
3. Text element types—static or moving
   i. letter—Report can show font, origins, education, etc
      a. The user can edit the shape of the font for this instantiation and/or additional instantiations
   ii. word—Report can show origins, synonyms, antonyms, thesaurus, dictionary, education
      a. noun—different types as discussed above
      b. verb
      c. adjective
      d. adverb
      e. pronoun
      f. etc
   iii. sentence
   iv. phrase
   v. clause
   vi. paragraph
   vii. document
   viii. chapter
   ix. book
   x. bibliography entry
   xi. printed document
   xii. parts of speech
      a. nouns
      b. verbs
      c. etc
   xiii. Boolean combinations
4. spreadsheet
   a. tables
5. slide show
6. graphics
   i. photo—user sees part of the image, all of the image, image can be static or it can be an animation. The movement of the animation can be seen from the View.
   ii. video
      a. video image—static or moving, i.e. a feed from a video camera
      b. news
   iii. TV show
   iv. drawing—2D drawing or 3 (or 4D) drawing projected into 2D
   v. charts
   vi. graphs
   vii. Venn Diagrams and other specific types of diagrams
   viii. images of objects in space
   ix. images of objects in Shows
   x. fax
7. Internet Objects
   i. RSS feed
   ii. audio feed
   iii. website, website page
   iv. blog
   v. email
   vi. chats
   vii. social media elements
      a. LinkedIn pages
      b. Instagram
      c. Facebook pages
      d. etc.
8. operating system operations from the Views Environment
   i. data files
   ii. directory operations
   iii. run and otherwise manipulate programs
   iv. etc.
9. apps
10. sensor input console
11. efferent control console
12. database
13. PDF types
   i. Dictionary
   ii. Strings
   iii. Boolean
   iv. Arrays
   v. Strings
   vi. null
13. Wolfram CDF Types
14. any other current or future important ones
15. Links to any of the above
16. Links to similar meanings and/or objects

What is claimed is:

1. A computer-implemented unit-conversion method comprising:
identifying a first numerical value with first unit of measure displayed on a computer-driven display;
converting said first numerical value with first unit of measure into a second numerical value with second unit of measure; and
displaying the second numerical value and second unit of measure on the computer-driven display wherein either said first unit of measure or said second unit of measure is a comparative unit of measure or said first unit of measure and said second unit of measure are comparative units of measure.

2. The method as claimed in claim 1 wherein a comparative unit comprises a unit that is not a member of a hitherto known set of units.

3. The method as claimed in claims 1 wherein identifying comprises selection by a user.

4. The method as claimed in claims 1 wherein said second unit of measure is determined based on an inferred preference that is inferred by collecting data on the usage patterns relating to usage of units.

5. The method as claimed in any one of claims 1 wherein displaying the second numerical value and the second unit of measure comprises displaying a text bubble or callout that presents the second numerical value and second unit of measure.

6. A computing device comprising:
a display to display a first numerical value with a first unit of measure on a computing device; and
a processor operatively coupled to a memory to identify the first unit of measure and to convert the first numerical value in the first unit of measure into a second numerical value in a second unit of measure and to cause the display to display the second numerical value and the second unit of measure wherein either said first unit of measure or said second unit of measure is a comparative unit of measure or said first unit of measure and said second unit of measure are comparative units of measure.

7. The method as claimed in claim 6 wherein a comparative unit comprises a unit that is not a member of a hitherto known set of units.

8. The computing device as claimed in claims 6 wherein the processor is configured to receive user input selecting the first numerical value and to convert the first numerical value in response to user input.

9. The computing device as claimed in claims 6 wherein said second unit of measure is determined based on an inferred preference that is inferred by collecting data on the usage patterns relating to usage of units.
